(19) United States
(12) Patent Application Publication
(10) Pub. No.: US 2024/0143405 A1
(43) Pub. Date: May 2, 2024

(54) APPARATUS FOR EXECUTING WORKFLOW TO PERFORM DISTRIBUTED PROCESSING ANALYSIS TASKS IN CONTAINER ENVIRONMENT AND METHOD FOR SAME

(71) Applicant: SAMSUNG SDS Co., Ltd., Seoul (KR)

(72) Inventors: Taeyeop KIM, Seoul (KR); Hoonki IM, Seoul (KR); Jungho LEE, Seoul (KR)

(73) Assignee: SAMSUNG SDS Co., Ltd., Seoul (KR)

(21) Appl. No.: 18/485,594

(22) Filed: Oct. 12, 2023

(30) Foreign Application Priority Data
Oct. 26, 2022 (KR) 10-2022-0138996

(51) Int. Cl. G06F 9/50; G06F 9/54

(52) U.S. Cl. CPC G06F 9/5038; G06F 9/5016; G06F 9/547

(57) ABSTRACT

A workflow execution apparatus and workflow execution method for processing distributed processing analysis tasks in a container environment including a user interface (UI) unit configured to receive an input target workflow of an analysis task to be processed, a workflow scheduler configured to retrieve resource templates executable by the target workflow from among a plurality of resource templates, and generate a final workflow by applying a resource configuration corresponding to the retrieved resource template to the target workflow according to a selected template, and a workflow worker configured to request execution of a distributed processing driver in a container environment, reuse a currently executed distributed processing driver when processing each of tasks included in the final workflow, and execute the final workflow.

### CROSS-REFERENCE TO RELATED APPLICATION(S)

This application claims the benefit under 35 U.S.C. 119 of Korean Patent Application No. 10-2022-0138996, filed on Oct. 26, 2022, in the Korean Intellectual Property Office, the entire disclosure of which is incorporated herein by reference for all purposes.

### BACKGROUND

### 1. Field

The disclosure relates to an apparatus for executing workflow to efficiently perform distributed processing analysis tasks in a container environment, and a method for the same.

### 2. Description of the Related Art

In general, when analysis tasks are performed by executing a distributed processing module within a container environment, the analysis tasks are processed by executing the distributed processing module such as a spark application or the like in the container environment such as Kubernetes. In other words, a user submitted the spark application to an API server provided by a Kubernetes cluster and executed a spark driver pod and a spark executor pod in a namespace to perform analysis tasks.

In this case, in order to execute the analysis module, the user inputs resource configurations of the spark driver and spark executor directly into execution scripts such as shell in which execution configurations are listed or configuration files such as YAML. However, when multiple tasks are to be performed separately, there existed inconvenience where the user had to input the same resource configurations for each execution script or configuration file every time.

In addition, even when the spark applications are executed using the execution scripts or the configuration files, each executed spark application is executed only once, and thus execution and suspension of the driver pod and executor pod are repeated every time analysis is executed. Since the driver pod and executor pod need to re-execute the spark context each time they are first driven and executed, and the execution of the spark context takes time, resulting in reduced time efficiency along with an increase in the number of times the driver pod and the executor pod are re-executed during the processing of analysis tasks. In particular, in workflow-based data analysis tasks where multiple tasks are executed one by one, there may be a significant time overhead due to the spark driver not being reused.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a workflow execution apparatus for processing distributed processing analysis tasks in a container environment including a user interface (UI) unit configured to receive an input target workflow of an analysis task to be processed, a workflow scheduler configured to retrieve resource templates executable by the target workflow from among a plurality of resource templates, and generate a final workflow by applying a resource configuration corresponding to the retrieved resource template to the target workflow according to a selected template, and a workflow worker configured to request execution of a distributed processing driver in a container environment, reuse a currently executed distributed processing driver when processing each of tasks included in the final workflow, and execute the final workflow.

The user UI unit includes a graphic user interface (GUI), and the user UI unit is configured to generate a target JavaScript object notation (JSON) document corresponding to the target workflow.

The distributed processing may be implemented by a spark application including a spark driver and a spark executor, and the resource configuration may include one or more of a number of cores and memory capacity allocated to the spark driver, a number of cores and memory capacity allocated to the spark executor, and a number of instances.

The workflow scheduler may be configured to generate a final JSON document corresponding to the final workflow by combining a resource JSON document corresponding to the retrieved resource template and the target JSON document.

The distributed processing may be implemented by the spark application including the spark driver and the spark executor, and the workflow worker may be configured to determine whether the spark driver is executed using a connection uniform resource locator (URL) address of the spark driver included in the resource configuration, reuse the spark driver when the spark driver is executed, and request execution of the spark driver when the spark driver is not executed.

The workflow execution apparatus may include a container manager unit configured to determine whether available resources of the container environment satisfy a final resource configuration of the final workflow.

The container environment may be implemented by Kubernetes, and the container manager unit is configured to generate a configuration file of the spark driver, based on the resource configuration of the final workflow and request execution of the spark driver from a Kubernetes master.

The workflow worker is configured to convert each of the tasks included in the final workflow into a remote procedure call message, transmit the remote procedure call message to the spark driver, and receive respective processing results for each of the tasks.

The workflow execution apparatus may include a workflow task receiver configured to operate within the spark driver, generate a user session corresponding to the remote procedure call message when receiving the remote procedure call message, execute the remote procedure call message in the user session, and return an execution result to the workflow worker.

In a general aspect, here is provided a workflow execution apparatus for processing distributed processing analysis tasks in a container environment, the workflow execution apparatus including one or more processors configured to execute instructions and a memory storing the instructions, wherein execution of the instructions configures the one or more processors to retrieve resource templates executable by a target workflow among a plurality of resource templates, generate a final workflow by applying a resource configuration corresponding to the retrieved resource template to the target workflow according to a selected template, request execution of a distributed processing driver in a container environment, reuse a currently executed distributed processing driver when processing each of tasks included in the final workflow, and execute the final workflow.

In a general aspect, here is provided a processor-implemented workflow execution method for processing distributed processing analysis tasks in a container environment including receiving a target workflow of an analysis task to be processed from a user interface unit, retrieving and providing resource templates executable by a target workflow, selected from the user interface unit from among a plurality of resource templates, generating a final workflow by applying a resource configuration corresponding to the resource templates to the target workflow according to a selected resource template, and requesting execution of a distributed processing driver in a container environment.

The receiving of the target workflow may include providing a GUI at the user interface and the receiving of the target workflow includes generating a target JSON document corresponding to the target workflow.

The distributed processing may be implemented by a spark application may include a spark driver and a spark executor, and the resource configuration may include one or more of a number of cores and memory capacity allocated to the spark driver, a number of cores and memory capacity allocated to the spark executor, and a number of instances.

The generating of the final workflow may include generating a final JSON document corresponding to the final workflow by combining a resource JSON document corresponding to the selected resource template and the target JSON document.

The method may include reusing a currently executed distributed processing driver when processing each of tasks included in the final workflow and executing the final workflow.

The distributed processing may be implemented by the spark application including the spark driver and the spark executor, and the executing of the final workflow may include inquiring whether the spark driver is executed using a connection URL address of the spark driver included in the resource configuration, reusing the spark driver when the spark driver is executed, and requesting execution of the spark driver when the spark driver is not executed.

The executing of the final workflow may include determining whether available resources of the container environment satisfy a final resource configuration of the final workflow.

The container environment may be implemented by Kubernetes, and the executing of the workflow may include generating a configuration of the distributed processing driver based on the resource configuration of the final workflow and requesting execution of the distributed processing driver.

The executing of the final workflow may include converting each of tasks included in the final workflow into a remote procedure call message, transmitting the remote procedure call message to the spark driver, and receiving respective processing results for each of the tasks.

The method may include reusing the currently executed distributed processing driver when processing each of tasks included in the final workflow and executing the final workflow, wherein the executing of the final workflow may include returning an execution result obtained by executing the remote procedure call message in a user session corresponding to the remote procedure call message from a workflow task receiver operating within the spark driver.

### BRIEF DESCRIPTION OF THE DRAWINGS

FIG. 1 is a block diagram illustrating a distributed processing analysis module.

FIGS. 2A-2D are exemplary diagrams illustrating a configuration file that a user of the distributed processing analysis module of FIG. 1 needs to manage.

FIG. 3 is a flowchart illustrating the operation of the distributed processing analysis module of FIG. 1.

FIG. 4 is a block diagram illustrating a workflow execution apparatus according to an embodiment of the disclosure.

FIG. 5 is a flowchart illustrating the operation of a workflow execution apparatus according to an embodiment of the disclosure.

FIG. 6 is an exemplary diagram illustrating a target workflow according to an embodiment of the disclosure.

FIG. 7 is an exemplary diagram illustrating a JSON document corresponding to a target workflow according to an embodiment of the disclosure.

FIG. 8 is an exemplary diagram illustrating a resource configuration of a resource template according to an embodiment of the disclosure.

FIG. 9 is an exemplary diagram illustrating a spark execution configuration YAML file generated by a container manager unit according to an embodiment of the disclosure.

FIG. 10 is a block diagram illustrating a workflow task receiver according to an embodiment of the disclosure.

FIG. 11 is an exemplary diagram illustrating workflow task execution according to an embodiment of the disclosure.

FIG. 12 is a block diagram illustrating a workflow execution apparatus according to another embodiment of the disclosure.

FIG. 13 is a flowchart illustrating a workflow execution method according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”). As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

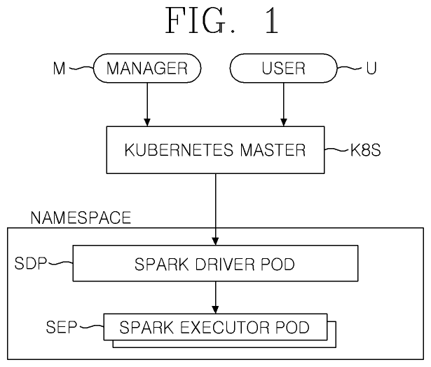

In general, in the case of performing analysis tasks by executing a distributed processing module in a container environment, as illustrated in FIG. 1, the analysis tasks were processed by executing the distributed processing module such as a spark application in the container environment such as Kubernetes. In other words, a user U submitted the spark application to an API server provided by a Kubernetes cluster, and executed a spark driver pod and a spark executor pod in a namespace to perform the analysis tasks.

Here, a manager M may manage the namespace in the Kubernetes for analysis resources, and the user U may execute the analysis module by providing a configuration file written as a YAML file to the Kubernetes master K8S. At this time, in order to execute the analysis module, the user U directly inputs resource configurations of the spark driver and spark executor into an execution script such as a shell in which execution configurations are listed, or a configuration file such as YAML. However, in the case of performing a plurality of tasks, it was necessary for the user U to input the same resource configuration each time for each execution script or configuration file.

In addition, even when the spark applications are executed using the execution scripts or the configuration files, each executed spark application is executed only once, and thus execution and suspension of the driver pod and executor pod are repeated every time analysis is executed. Since the driver pod and executor pod need to re-execute the spark context each time they are first driven and executed, and the execution of the spark context takes time, resulting in reduced time efficiency along with an increase in the number of times the driver pod and the executor pod are re-executed during the processing of analysis tasks. In particular, in workflow-based data analysis tasks where multiple tasks are executed one by one, there may be a significant time overhead due to the spark driver not being reused.

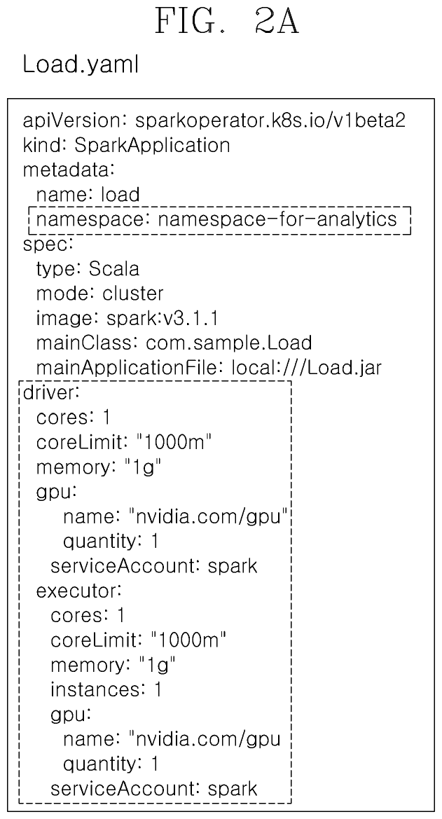

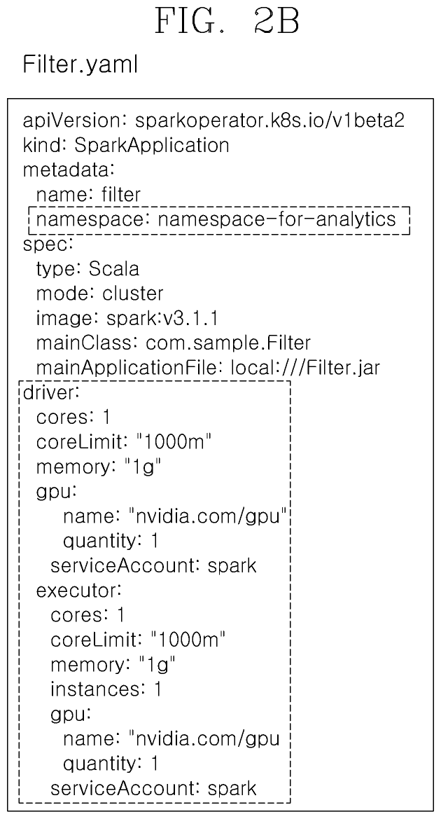

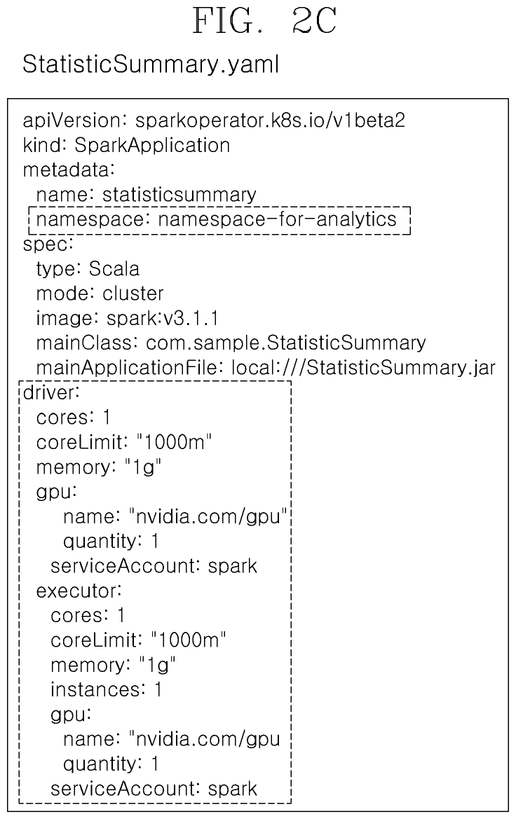

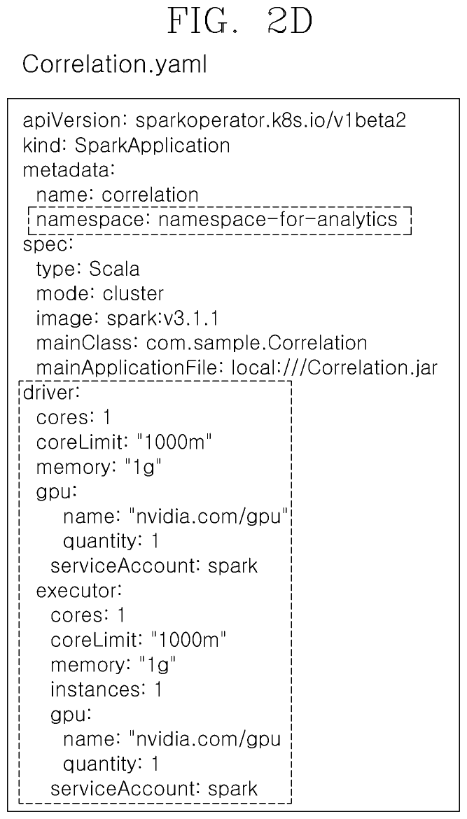

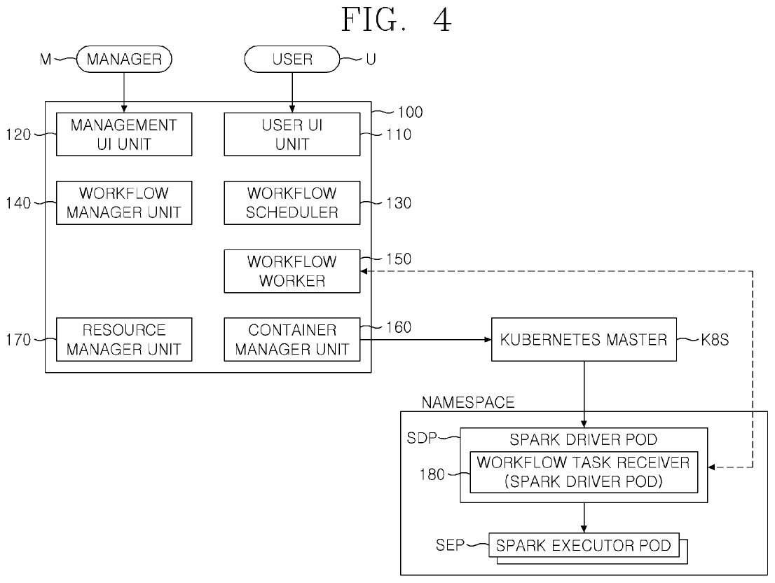

For example, when the user wants to perform Load, Filter, and Statistic Summary analysis sequentially, the user needs to create and manage each YAML file to perform analysis, as illustrated in FIGS. 2A to 2D. Here, when the user wants to additionally perform correlation analysis, the user needs to additionally create and manage a separate YAML file for correlation analysis as illustrated in FIG. 4D.

In addition, when the user wants to change the core and memory configuration for each driver and executor, the user needs to manually modify the resource configurations written in the configuration file, Load.yaml, filter.yaml, statisticSummary.yaml, and Correlation.yaml. In addition, when the namespace for the analysis resource is changed, there is inconvenience such as the user having to change all the values of metadata namespace in each file.

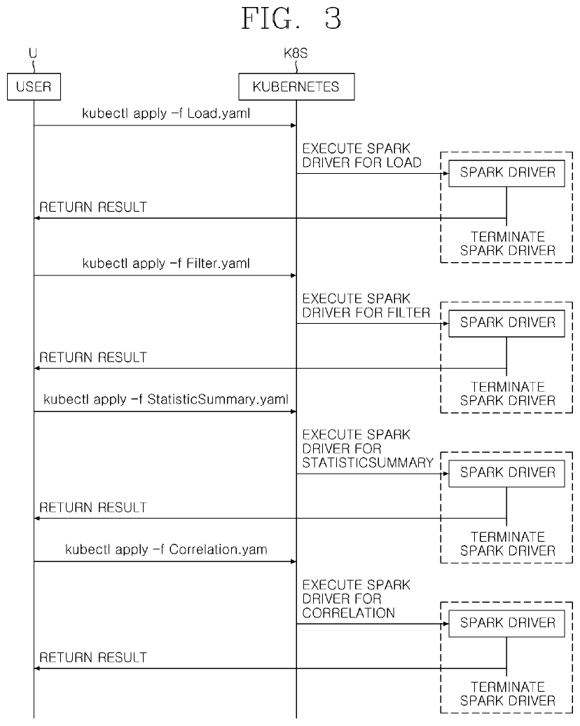

Additionally, referring to FIG. 3, when the user sequentially executes Load.yaml, filter.yaml, statisticSummary.yaml, and Correlation.yaml, it may be identified that the spark driver used for each analysis is terminated for each analysis. That is, in order to execute Filter.yaml after Load.yaml, a new spark driver needs to be executed, and since the spark driver is terminated and executed for each analysis task, time overhead occurs.

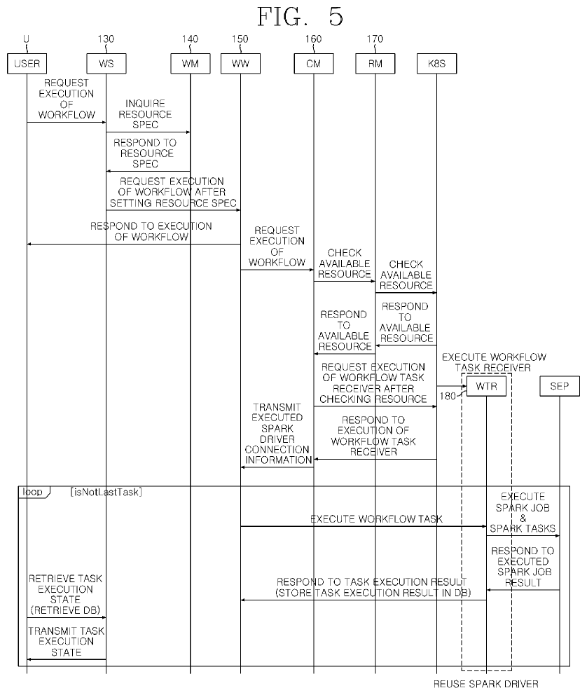

Meanwhile, since the workflow execution apparatus according to an embodiment of the disclosure reuses the resource configuration during workflow execution, the user does not need to manage the same resource determination repeatedly. Through reuse of a distributed processing driver, it is possible to reduce overhead according to the execution of the driver. Hereinafter, a workflow execution apparatus according to an embodiment of the disclosure will be described with reference to FIGS. 4 and 5.

FIG. 4 is a block diagram illustrating a workflow execution apparatus according to an embodiment of the disclosure, and FIG. 5 is a flowchart illustrating the operation of a workflow execution apparatus according to an embodiment of the disclosure.

Referring to FIGS. 4 and 5, a workflow execution apparatus 100 according to an embodiment of the disclosure may include a user UI unit 110, a management UI unit 120, a workflow scheduler 130, a workflow manager unit 140, a workflow worker 150, a container manager unit 160, a resource manager unit 170, and a workflow task receiver 180.

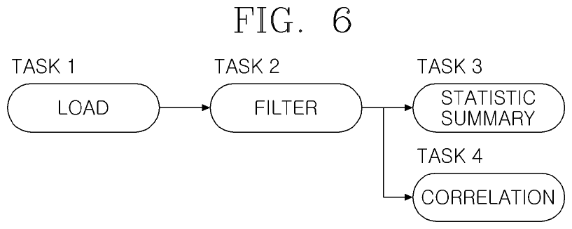

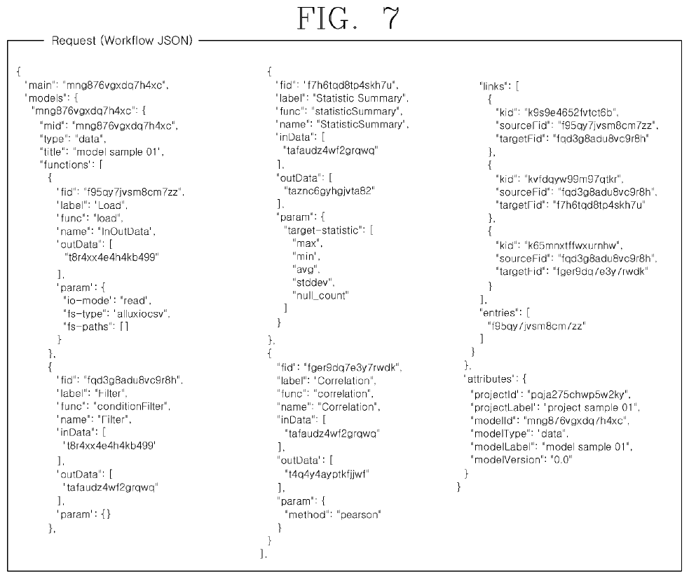

The user UI unit 110 may receive a target workflow of an analysis task to be processed from the user U. Here, as illustrated in FIG. 6, the user UI unit 110 may receive the target workflow in the form of a graphic user interface (GUI). The user U may allow multiple tasks (Load, Filter, Statics Summary, Correlation) to be included in the target workflow, and may configure the execution order and connection relationships of the tasks, branching, etc., to perform Task 1->Task 2->Task 3 and Task 1->Task 2->Task 4. In addition, the user U may use the user UI unit 110 to configure details of each task. Meanwhile, the user UI unit 110 may generate a target JavaScript object notation (JSON) document corresponding to the target workflow. That is, as illustrated in FIG. 7, a target JSON document required for the execution of the target workflow may be automatically generated.

The management UI unit 120 may provide a manager UI to generate a resource template corresponding to each resource configuration input by the manager M. Here, the resource configuration may be the number of cores and memory capacity allocated to the spark driver, the number of cores and memory capacity allocated to the spark executor, and the number of instances. That is, definitions of resources necessary for executing the workflow may be stored. Here, the case of utilizing the spark application using the distributed processing module is exemplified, but other than that, resource configurations of various distributed processing modules for distributed processing may be stored as resource templates.

The workflow scheduler 130 may receive an execution request for the target workflow input from the user UI unit 110, and retrieve and provide resource templates executable by the target workflow among a plurality of resource templates, in response to the execution request. The workflow manager unit 140 may store and manage the resource templates generated by the management UI unit 120, and provide the executable resource templates to the workflow scheduler 130 in response to a resource spec inquiry request from the workflow scheduler 130.

Next, the workflow scheduler 130 may generate a final workflow by applying the resource configuration corresponding to the resource template to the target workflow according to the user's selection. That is, the user may easily complete the resource configuration simply by selecting the resource template generated in advance by the manager M, without the configuration file such as YAML for distributed processing.

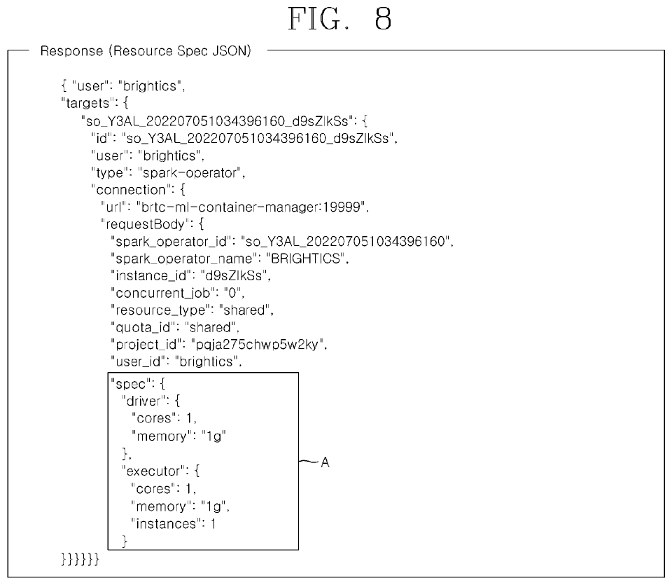

Depending on the embodiments, the workflow scheduler 130 may generate a final JSON document corresponding to the final workflow by combining a resource JSON document corresponding to the resource template and a target JSON document. That is, FIG. 8 shows a portion of the final JSON document, and corresponds to a portion in which the “spec” item corresponding to area A is added from the resource JSON document corresponding to the resource template.

When the final workflow is generated, the workflow scheduler 130 may request execution of the final workflow from the workflow worker 150, and in this case, the workflow worker 150 may request execution of the distributed processing driver in the container environment.

Here, the workflow worker 150 may inquire (e.g., determine) whether the spark driver is being executed by using a connection uniform resource locator (URL) address of the spark driver included in the resource configuration. Specifically, referring to the “connection” item of FIG. 8, it may be identified that the connection URL address for connection to the spark driver is provided. Next, when the spark driver is being executed, the workflow worker 150 may reuse the corresponding spark driver to execute the final workflow. On the other hand, when the spark driver is not currently executed, it is possible to request execution of a new spark driver from the container manager unit 160. Depending on the embodiments, the execution of the new spark driver may be requested by referring to the “requestBody” item of FIG. 8. The container manager unit 160 may receive a request for the execution of the new spark driver from the workflow worker 150, and in response to this, may identify (e.g. determine) whether available resources of the container environment satisfy the resource configuration of the final workflow. The resource manager unit 170 may periodically or aperiodically identify the container resource status using a Kubernetes master K8S to manage the available resources in Kubernetes. Accordingly, the container manager unit 160 may identify the available resources from the resource manager unit 170 when the workflow worker 150 requests the execution, and determine whether the corresponding available resources satisfy the resource configuration of the final workflow.

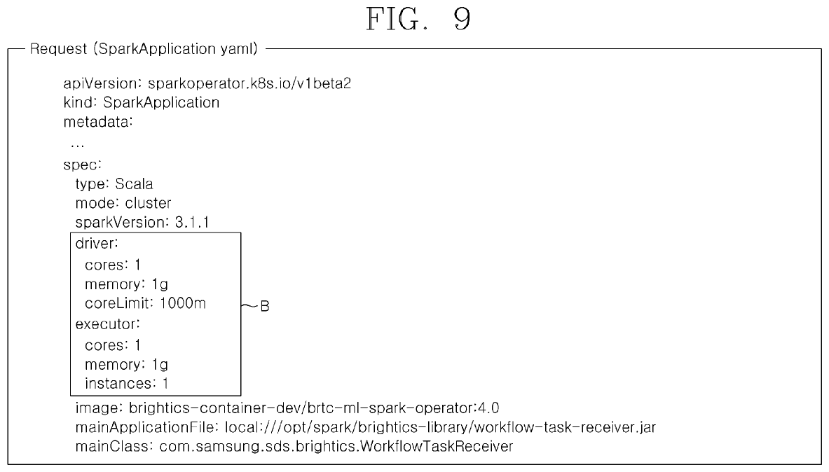

Next, when the available resources satisfy the resource configuration of the final workflow, the container manager unit 160 may generate a configuration file of the spark driver based on the resource configuration of the final workflow. That is, conventionally, the user had to generate a YAML configuration file for spark application execution and request the execution from the Kubernetes master K8S, and when the resource configuration is changed, each YAML configuration file had to be modified one by one. However, in this case, it is possible for the container manager unit 160 to automatically generate the configuration file shown in FIG. 9 and request the execution. At this time, it may be identified that all the resource configurations included in area B of FIG. 8 can be automatically input.

When the configuration file of the spark driver is generated, the container manager unit 160 may request execution of the spark driver from the Kubernetes master K8S.

The Kubernetes master K8S may execute the spark driver according to the configuration file, where the workflow task receiver 180 may be executed in the spark driver. The Kubernetes master K8S may notify the container manager unit 160 of the execution of the spark driver, and the container manager unit 160 may provide the workflow worker 150 with access information on the spark driver.

In this case, the workflow worker 150 may convert each task included in the final workflow into a remote procedure call (RPC) message and transmit the message to the spark driver. The workflow task receiver 180 may receive the remote procedure call message from the workflow worker 150, identify a user of the remote procedure call message, and generate a user session corresponding thereto. Next, within the spark context, the remote procedure call messages of the user session may be divided into a plurality of unit tasks for distributed processing, and each unit task may be distributed to the spark executor pods. Execution results performed in spark executor pods may be aggregated and returned to the workflow workers.

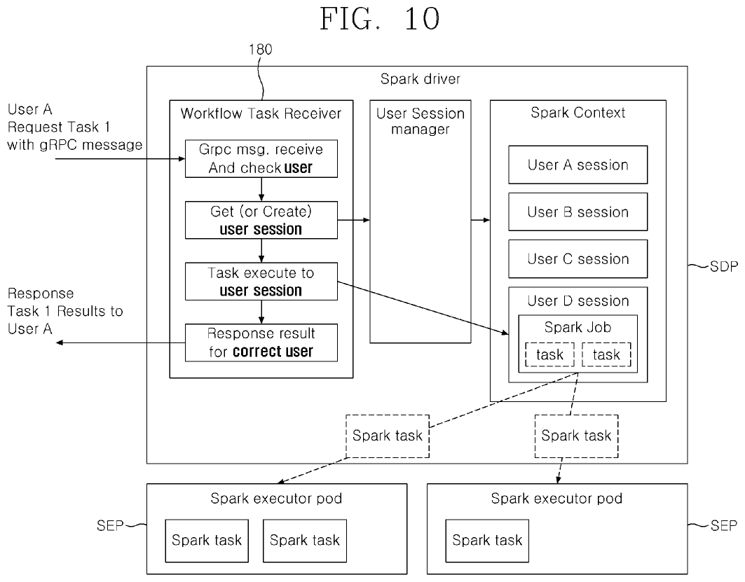

Here, when receiving the remote procedure call messages from a plurality of users, the workflow task receiver 180 may configure the user session for each user so that data analysis task may be performed in a space independent from each other. At this time, the workflow task receiver 180 may reuse each spark context. That is, as illustrated in FIG. 10, when user A transmits a message gRPC for task 1, the workflow task receiver 180 may determine the user session of the user by identifying the user of the received message gRPC. Next, the corresponding task may be performed in the user session, but when the same task is performed in the user session of another user D, it is also possible to reuse the corresponding spark context to perform the analysis. Next, when returning the execution result, the user of the message gRPC is identified, and the result of task 1 may be returned to user A.

Meanwhile, within the user session, tasks requested by each user may be changed into a spark job form, which is a structure executable in spark. Next, each spark job may be divided into several unit tasks for distributed processing, and the unit tasks may be requested to be executed from the spark executors, and may be distributed in parallel. Next, when processing of unit tasks for a specific spark job is completed in each executor, the spark job may be completed, and the workflow task receiver 180 may transmit an execution completion response of the corresponding task to the user.

Here, the workflow worker 150 may reuse the currently executed distributed processing driver when processing each task included in the final workflow. Conventionally, since only the spark context is executed in the spark driver, when the spark context is terminated, the spark driver is no longer maintained and terminated. On the other hand, the workflow task receiver 150 may be additionally executed on the spark driver, and the workflow task receiver may affect the life cycle of the spark driver. That is, while the workflow task receiver 150 is being executed, the spark driver may not be terminated, and the tasks included in the workflow may be continuously processed.

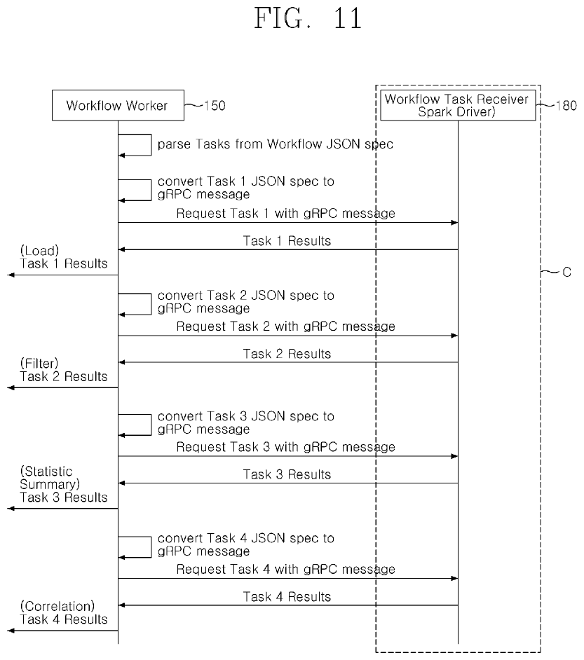

Specifically, referring to FIG. 11, the workflow worker 150 may divide the plurality of tasks included in the workflow and first convert task 1 into a message gRPC form. Next, the workflow worker 150 may transmit the message gRPC for task 1 to the workflow task receiver 180, and the workflow task receiver 180 may provide the execution result of task 1 to the workflow worker 150. Here, the workflow task receiver 180 may not be terminated and may receive a message gRPC for task 2 from the workflow worker 150. That is, it is possible to process task 2 by reusing the same workflow task receiver 180. Tasks 3 to 4 may be performed in the same way, and it may be identified that the workflow task receiver 180 is maintained and reused while tasks 1 to 4 are performed (area C).

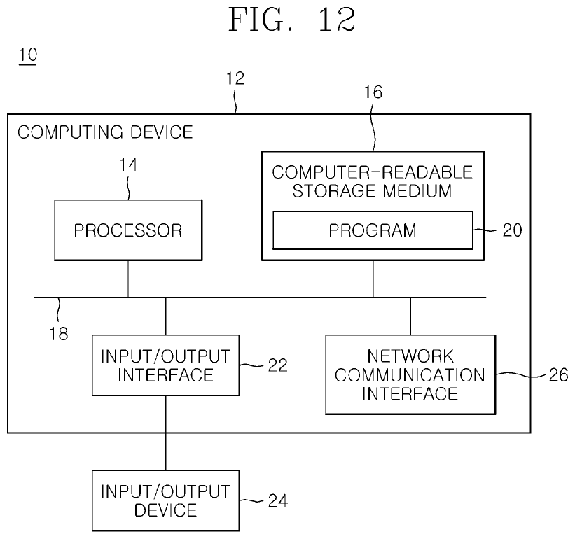

FIG. 12 is a block diagram illustrating a computing environment 10 suitable for use in example embodiments. In the illustrated embodiment, respective components may have different functions and capabilities other than those described below, and additional components other than those described below may be included.

The illustrated computing environment 10 includes a computing device 12. In an embodiment, the computing device 12 may be a workflow execution apparatus (e.g., the workflow execution apparatus 100) for processing distributed processing analysis tasks in a container environment.

The computing device 12 includes at least one processor 14, a computer-readable storage medium 16, and a communication bus 18. The processor 14 may cause the computing device 12 to operate according to the above-mentioned example embodiments. For example, the processor 14 may execute one or more programs stored on a computer-readable storage medium 16. The one or more programs may include one or more computer-executable instructions, and the computer-executable instructions may be configured to cause the computing device 12 to perform operations according to the exemplary embodiment when the computer-executable instructions are executed by the processor 14.

The computer-readable storage medium 16 is configured to store the computer-executable instructions or program code, program data, and/or other suitable form of information. The program 20 stored in the computer-readable storage medium 16 includes a set of instructions executable by processor 14. In an embodiment, the computer-readable storage medium 16 may include memory (volatile memory such as random access memory, non-volatile memory, or a suitable combination thereof), one or more magnetic disk storage devices, optical disk storage devices, flash memory devices, other types of storage media that is accessible by the computing device 12 and store desired information, or a suitable combination thereof.

The communication bus 18 interconnects various other components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output devices 24 may include a pointing device (such as a mouse or trackpad), a keyboard, a touch input device (such as a touchpad or touchscreen), a voice or sound input device, various types of sensor devices, and/or input devices such as a photographing device, and/or output devices such as a display device, a printer, a speaker, and/or network cards. The exemplary input/output device 24 may be included inside the computing device 12 as a component constituting the computing device 12, or may be connected to the computing device 12 as a separate device distinct from the computing device 12.

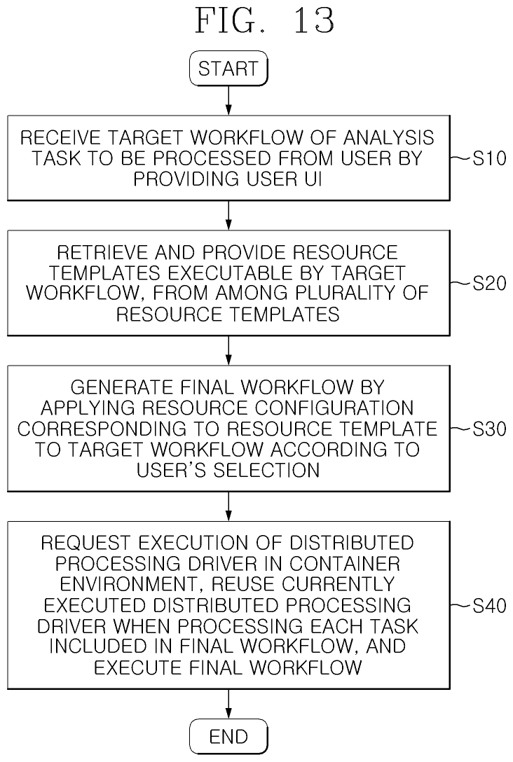

FIG. 13 is a flowchart illustrating a workflow execution method according to an embodiment of the disclosure. Here, each operation of FIG. 13 may be performed by a workflow execution apparatus according to an embodiment of the disclosure.

Hereinafter, a workflow execution method according to an embodiment of the disclosure will be described with reference to FIG. 13.

In operation S10, the workflow execution apparatus may provide a UI to receive a target workflow of an analysis task to be processed from a user. Depending on the embodiments, the target workflow may be received in the form of a GUI from the user, and the user may allow a plurality of tasks to be included in the target workflow and configure execution orders, connection relationships, and branching of the respective tasks. Here, the workflow execution apparatus may automatically generate a target JSON document corresponding to the target workflow input by the user.

Next, in operation S20, when an execution request for the target workflow input from the user is received, the workflow execution apparatus may retrieve and provide resource templates executable by the target workflow from among a plurality of resource templates. Here, the workflow execution apparatus may implement distributed processing using a spark application including a spark driver and a spark executor. In this case, the resource configuration may include the number of cores and memory capacity allocated to the spark driver, the number of cores and memory capacity allocated to the spark executor, and the number of instances.

Next, in operation S30, the workflow execution apparatus may generate a final workflow by applying the resource configuration corresponding to the resource template to the target workflow according to a user's selection. In other words, the user may easily complete the resource configuration by simply selecting the pre-generated resource template without a configuration file such as YAML for distributed processing. Depending on the embodiments, it is also possible to generate a final JSON document corresponding to the final workflow by combining a resource JSON document corresponding to the resource template and a target JSON document.

Next, in operation S40, the workflow execution apparatus may request execution of the distributed processing driver in the container environment, reuse the currently executed distributed processing driver when processing each task included in the final workflow, and execute the final workflow.

Specifically, the workflow execution apparatus may inquire whether a spark driver corresponding to the distributed processing driver is being executed using a connection URL address of the spark driver included in the resource configuration. Here, when the spark driver is being executed, the workflow execution apparatus may reuse the corresponding spark driver to execute the final workflow. On the other hand, when the spark driver is not being executed, execution of a new spark driver may be requested.

Here, in order to execute the new spark driver, first, whether available resources of the container environment satisfy the resource configuration of the final workflow may be identified. That is, the workflow execution apparatus may periodically or aperiodically identify the container resource status to manage the available resources of Kubernetes. Accordingly, when the new spark driver is executed, the available resources of Kubernetes may be identified, and whether the available resources satisfy the resource configuration of the final workflow may be determined.

Next, when the available resources satisfy the resource configuration of the final workflow, a configuration file of the spark driver may be generated based on the resource configuration of the final workflow. That is, it is possible for the workflow execution apparatus to automatically generate the configuration file and request execution of the spark driver.

When the configuration file of the spark driver is generated, it is possible to request execution of the spark driver from the Kubernetes master, and the Kubernetes master may execute the spark driver according to the configuration file. Here, the workflow task receiver may be executed in the spark driver.

In this case, the workflow execution apparatus may convert each task included in the final workflow into a remote procedure call message and transmit the message to the spark driver, and the workflow task receiver may identify the user of the remote procedure call message and generate a corresponding user session. Next, within the spark context, the remote procedure call messages of the user session may be divided into a plurality of unit tasks for distributed processing, and each unit task may be distributed to the spark executor pod. Next, execution results performed in the spark executor pods may be collected and returned to the workflow execution apparatus.

Here, the workflow execution apparatus may reuse the currently executed distributed processing driver when processing each task included in the final workflow. That is, while the workflow execution apparatus performs a plurality of tasks included in the final workflow, the spark driver may be maintained and reused.

The methods, processes, workflow execution apparatus 100, the user UI unit 110, the management UI unit 120, the workflow scheduler 130, the workflow manager unit 140, the workflow worker 150, the container manager unit 160, the resource manager unit 170, the workflow task receiver 180, the computing device 12, the processor 14, and the computer-readable storage medium 16 described herein and disclosed herein described with respect to FIGS. 1-13 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A workflow execution apparatus for processing distributed processing analysis tasks in a container environment, the workflow execution apparatus comprising:
a user interface (UI) unit configured to receive an input target workflow of an analysis task to be processed;
a workflow scheduler configured to:
retrieve resource templates executable by the target workflow from among a plurality of resource templates; and
generate a final workflow by applying a resource configuration corresponding to the retrieved resource template to the target workflow according to a selected template; and
a workflow worker configured to:
request execution of a distributed processing driver in a container environment;
reuse a currently executed distributed processing driver when processing each of tasks included in the final workflow; and
execute the final workflow.

2. The workflow execution apparatus of claim 1, wherein the user UI unit includes a graphic user interface (GUI), and
wherein the user UI unit is configured to generate a target JavaScript object notation (JSON) document corresponding to the target workflow.

3. The workflow execution apparatus of claim 1, wherein the distributed processing is implemented by a spark application comprising a spark driver and a spark executor, and
wherein the resource configuration comprises one or more of a number of cores and memory capacity allocated to the spark driver, a number of cores and memory capacity allocated to the spark executor, and a number of instances.

4. The workflow execution apparatus of claim 2, wherein the workflow scheduler is configured to generate a final JSON document corresponding to the final workflow by combining a resource JSON document corresponding to the retrieved resource template and the target JSON document.

5. The workflow execution apparatus of claim 3, wherein the distributed processing is implemented by the spark application comprising the spark driver and the spark executor, and
wherein the workflow worker is configured to:
determine whether the spark driver is executed using a connection uniform resource locator (URL) address of the spark driver included in the resource configuration;
reuse the spark driver when the spark driver is executed; and
request execution of the spark driver when the spark driver is not executed.

6. The workflow execution apparatus of claim 3, further comprising a container manager unit configured to determine whether available resources of the container environment satisfy a final resource configuration of the final workflow.

7. The workflow execution apparatus of claim 6, wherein the container environment is implemented by Kubernetes, and
wherein the container manager unit is configured to:
generate a configuration file of the spark driver, based on the resource configuration of the final workflow; and
request execution of the spark driver from a Kubernetes master.

8. The workflow execution apparatus of claim 7, wherein the workflow worker is configured to:
convert each of the tasks included in the final workflow into a remote procedure call message;
transmit the remote procedure call message to the spark driver; and
receive respective processing results for each of the tasks.

9. The workflow execution apparatus of claim 8, further comprising a workflow task receiver configured to:
operate within the spark driver;
generate a user session corresponding to the remote procedure call message when receiving the remote procedure call message;
execute the remote procedure call message in the user session; and
return an execution result to the workflow worker.

10. A workflow execution apparatus for processing distributed processing analysis tasks in a container environment, the workflow execution apparatus comprising:
one or more processors configured to execute instructions; and
a memory storing the instructions, wherein execution of the instructions configures the one or more processors to:
retrieve resource templates executable by a target workflow among a plurality of resource templates;
generate a final workflow by applying a resource configuration corresponding to the retrieved resource template to the target workflow according to a selected template;
request execution of a distributed processing driver in a container environment;
reuse a currently executed distributed processing driver when processing each of tasks included in the final workflow; and
execute the final workflow.

11. A processor-implemented workflow execution method for processing distributed processing analysis tasks in a container environment, the workflow execution method comprising:
receiving a target workflow of an analysis task to be processed from a user interface unit;
retrieving and providing resource templates executable by a target workflow, selected from the user interface unit from among a plurality of resource templates;
generating a final workflow by applying a resource configuration corresponding to the resource templates to the target workflow according to a selected resource template; and
requesting execution of a distributed processing driver in a container environment.

12. The workflow execution method of claim 11, wherein the receiving the target workflow comprises providing a GUI at the user interface,
and wherein the receiving of the target workflow comprises generating a target JSON document corresponding to the target workflow.

13. The workflow execution method of claim 11, wherein the distributed processing is implemented by a spark application comprising a spark driver and a spark executor, and
wherein the resource configuration comprises one or more of a number of cores and memory capacity allocated to the spark driver, a number of cores and memory capacity allocated to the spark executor, and a number of instances.

14. The workflow execution method of claim 12, wherein the generating of the final workflow comprises generating a final JSON document corresponding to the final workflow by combining a resource JSON document corresponding to the selected resource template and the target JSON document.

15. The workflow execution method of claim 13, further comprising:
reusing a currently executed distributed processing driver when processing each of tasks included in the final workflow; and
executing the final workflow.

16. The workflow execution method of claim 15, wherein the distributed processing is implemented by the spark application comprising the spark driver and the spark executor, and
wherein the executing of the final workflow comprises:
inquiring whether the spark driver is executed using a connection URL address of the spark driver included in the resource configuration;
reusing the spark driver when the spark driver is executed; and
requesting execution of the spark driver when the spark driver is not executed.

17. The workflow execution method of claim 15, wherein the executing of the final workflow comprises determining whether available resources of the container environment satisfy a final resource configuration of the final workflow.

18. The workflow execution method of claim 13, wherein the container environment is implemented by Kubernetes, and
wherein the executing of the workflow comprises:
generating a configuration of the distributed processing driver based on the resource configuration of the final workflow; and
requesting execution of the distributed processing driver.

19. The workflow execution method of claim 13, wherein the executing of the final workflow comprises:
converting each of tasks included in the final workflow into a remote procedure call message;
transmitting the remote procedure call message to the spark driver; and
receiving respective processing results for each of the tasks.

20. The workflow execution method of claim 19, further comprising:
reusing the currently executed distributed processing driver when processing each of tasks included in the final workflow; and
executing the final workflow, wherein the executing of the final workflow comprises returning an execution result obtained by executing the remote procedure call message in a user session corresponding to the remote procedure call message from a workflow task receiver operating within the spark driver.
